(19) United States
(12) Patent Application Publication
(10) Pub. No.: US 2005/0144385 A1
(43) Pub. Date: Jun. 30, 2005

(54) Interfacing multiple flash memory cards to a computer system

(76) Inventors: Keith R. Mowery, Plano, TX (US); William F. Harris, Richardson, TX (US); Takeshi Sakai, Richardson, TX (US)

Correspondence Address: TEXAS INSTRUMENTS INCORPORATED, P O BOX 655474, M/S 3999, DALLAS, TX, 75265, US

(21) Appl. No.: 10/970,088

(22) Filed: Oct. 20, 2004

Related U.S. Application Data
(60) Provisional application No. 60/533,189, filed on Dec. 30, 2003.

(51) Int. Cl. G06F 12/00

(52) U.S. Cl. 711/115

(57) ABSTRACT

A card controller for a computer system allows the insertion of flash memory cards which share a common socket into a computer system for which there is no standardized driver for at least one of the card types. The system can accommodate MMC, SD and SDIO cards in personal computers by having two controllers within the card control circuit, one of which is a standardized controller having a standardized software driver, which can support at least one of the card types that can be inserted into the socket. The other controller is a non-standardized controller which has its own non-standardized software driver, and supports at least another card type that can be inserted into the socket. The non-standardized controller powers up the card upon receiving a card detect signal and determines if it's a card type that it supports. If it is, it supports the card in a normal fashion. If it is not, it sets a switch bit, and powers down the card. The switch bit switches a multiplexer to switch the signals to/from the card from the non-standardized controller to the standardized controller. The card detect signal is asserted to the standardized controller, which sends an interrupt to the standardized software driver, to activate the driver. The software driver powers up and initializes the card, reports the presence of the card to the operating system, and operates with the card normally. When the card is removed from the socket, the card detect signal alerts the switching controller to switch the multiplexer so that these signals are again sent to the non-standardized controller, and the process repeats.

### RELATED APPLICATION

This Application claims the benefit of Application Ser. No. 60/533,189 filed Dec. 30, 2003.

### FIELD OF THE INVENTION

The present invention relates to a flash memory card system for a computer system and more particularly to a system with MMC, SD and SDIO cards for personal computers.

### BACKGROUND OF THE INVENTION

Flash memory cards meet the need for the rapidly growing demand for memory in portable electronic devices such as digital cameras, digital video camcorders, audio players, multi-function 2.5 G/3 G cell phones, PDAs and other portable electronic devices. There are three card types that are in general use. The MultiMedia Card (MMC card) can now store as much as 1 GB of data to provide up to 30 hours of digitally compressed music, 320 minutes of MPEG-4 compressed video or 1,000 high-resolution digital images. The Secure Digital card (SD card) supports copyright protection for the distribution of copyrighted material, such as copyrighted movies or music. The Secure Digital Input Output card (SDIO card) has the same connectivity as the SD card and provides input/output capability to the system. For example, SDIO cards enabling the connectivity via 802.11b (WiFi) networks are now available.

The digitally stored information on these cards will often need to be downloaded into a computer system for further processing, such as the editing of video or the touching up of still photos. Additionally, data generated within a computer system, such as digital music captured from non-digital audio sources, needs to be uploaded to and stored on these memory cards. The input/output capabilities of the SDIO cards makes this an easy way to expand the connectivity of the computer system. This need and the fact that the three card types share a common socket, makes the expansion of computer systems to provide this function a sought after feature.

Inside a personal computer, for example, the card is connected to a hardware controller of a type which is known in the art, and the hardware controller is operated by a software driver stored within the computer system. A standardized software driver is available for a standardized hardware controller but the standardized software driver only supports SD and SDIO cards. It does not support MMC cards. A standardized software driver for the standardized hardware controller to support MMC cards is not currently available nor will one be made available in the future. Additionally, a non-standardized software drive is available for a non-standardized hardware controller, but the non-standardized software driver only supports MMC and SD cards. It cannot support SDIO cards. The need for the software driver to interface with the operating system of the personal computer, for example, limits the ability to generate this software driver. Accordingly, there is a need for a system for supporting all three card types in a computer system environment.

### SUMMARY OF THE INVENTION

It is a general object of the present invention to provide a system for a method for interfacing multiple types of flash memory cards to a computer system.

This and other features and advantages are provided, in accordance with one aspect of the invention by a method of operating a computer system to communicate with a memory card. A card detect signal from a card socket is detected by a non-standardized controller. A first software driver for the non-standardized controller is activated. The memory card is powered and a memory card type determined by the first software driver. If the memory card type detected is not supported by the non-standardized controller, signals from/to the memory card are switched to the standardized controller. The card detect signal from the card socket is detected by the standardized controller. A second software driver for the standardized controller is activated. The memory card is powered and the memory card communicates with the second software driver.

Another aspect of the invention includes a computer system having a socket for communicating with a memory card. A memory card socket receives a memory card therein. A memory card detector detects the presence of the memory card in the socket and generates a card detect signal. A non-standardized controller is coupled to the socket for receiving and detecting the card detect signal. A first software driver within the computer system drives and powers the memory card via the non-standardized controller, the first driver determining memory card type. A switch couples signals from/to the memory card socket to the non-standardized controller at a first setting to a standardized controller at a second setting, the switch being responsive to the determined memory type, the standardized controller detecting the card detect signal and activating a second software driver in the computer system for driving and powering the memory card via the standardized controller, the second driver communicating with the memory card.

### BRIEF DESCRIPTION OF THE DRAWINGS

FIG. 1 is a block diagram of a hardware controller capable interfacing with all three memory card types; and

FIG. 2 is a flow chart of a software driver for the hardware controller of FIG. 1.

### DETAILED DESCRIPTION OF THE PRESENT INVENTION

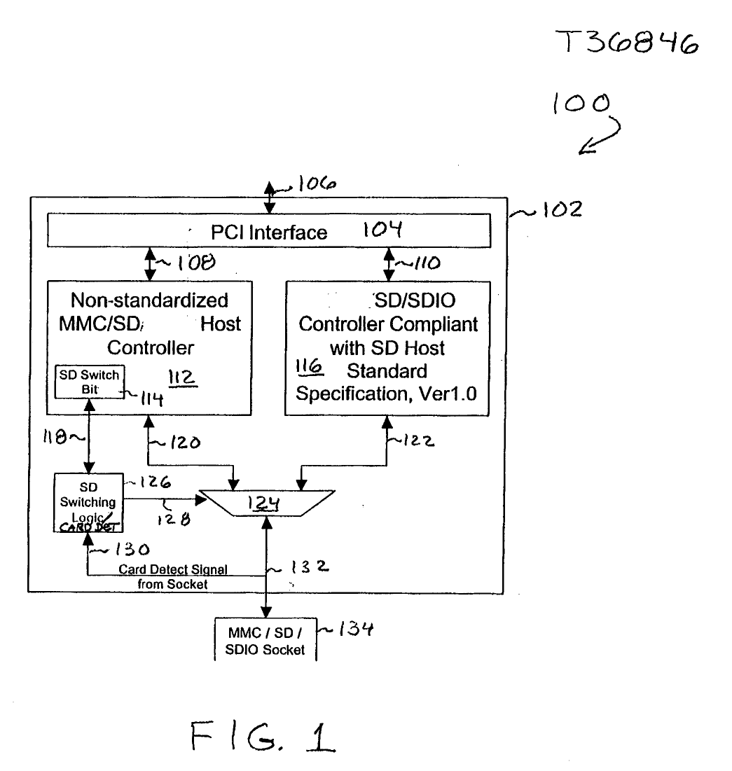

FIG. 1 shows a block diagram of a memory card reader system, generally shown as 100, within a personal computer system (not shown). A card socket 134 can accept MMC, SD, or SDIO cards, all of which use a standardized connector, and thus can share a common socket design. The socket contains a pin which generates a card detect signal on bus 132 which is also branched to line 130 when one of the three types of cards is inserted into the socket 134. The card detect signal on line 130 is coupled to SD switching logic/card detect circuit 126. The signals from the card on bus 132 are coupled to multiplexer 124 which is controlled by the signal on line 128. Depending on the signal on line 28, the multiplexer couples the signals on bus 132 to the non-standardized controller 112 via bus 120 or to the standardized controller 116 via bus 122. The non-standardized controller 112 is coupled via two-way bus 108 to a PCI interface 104, and the standardized controller is coupled via two way bus 110 to interface 104. Interface 104 can also be a PCI Express or other internal interface used by the computer system to connect peripherals to the remainder of the computer system (not shown) via two way bus 106, as is well known to those skilled in the art.

The standardized SD card/SDIO controller which is compliant with the SD Host Controller Standard Specification 116 is well known in the art and readily available. Also well known and readily available is the software driver for this controller for use in personal computer environments, for example. Non-standardized MMC/SD controllers are also know in the art and software drivers for these devices are readily generated by those skilled in the art, and need not be described in detail herein.

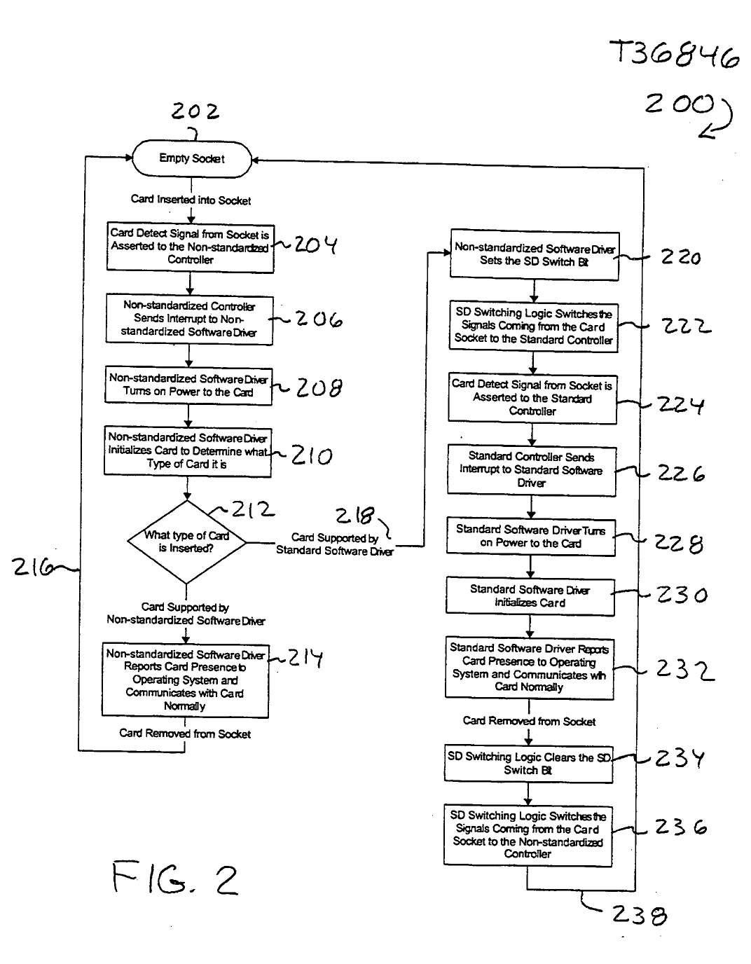

Operation of the circuit 100 will now be explained in connection with the flow chart of FIG. 2, shown generally as 200. The operation begins at block 202 when a card in inserted into an empty socket. The card detect sigrial from the socket is coupled via branch line 130 to the SD switching logic/card detect circuit 126. It is also coupled via bus 132 to multiplexer 124 and via bus 120 to the non-standardized controller 112 and asserted to this controller at block 204. Control passes to block 206 where the non-standardized controller 112 sends an interrupt signal across two way bus 108, through PCI interface 104 and two way bus 106 to the non-standardized software driver in the computer system. Control passes to block 208 where the non-standardized software driver is activated and operates the non-standardized controller 112 to turn power on to the card inserted into socket 134. Control passed to block 210 in which the non-standardized software driver initializes the card to determine the type of card that has been inserted into socket 134, that is, an MMC, SD or SDIO card. At block 212, the software driver determines the type of card that has been inserted based on the card's response to the initialization. If the card type is supported by the non-standardized software driver, control passes to block 214 at which communication between the non-standardized software driver and the card proceeds normally. Control remains at block 214 until the card is removed from the socket. When this occurs, control passes along line 216 back to the empty socket state at block 202.

If the card is a type not support by the non-standardized driver and supported by standard software driver, control passes along line 218 to block 220 in which the non-standardized software driver sets the SD switch bit 114 within the non-standardized host controller 112. The non-standardized host controller 112 powers down the card and control passes to block 222. At block 222, the SD switching logic responds to the set bit 114 and generates a signal on line 128 to control multiplexer 124 to switch the signals on bus 132 coming from the card inserted into socket 134 from the output along two way bus 120 to non-standardized controller 112 to being output on two way bus 122 to standardized controller 116. Control passes to block 224 in which the card detect signal from the card bus 132, is asserted via multiplexer 124 and bus 122 to the standardized controller 116. Control passes to block 226 in which the standardized controller 116 sends an interrupt via two way bus 110, PCI interface 104 and two way bus 106 to the standardized software driver in the computer system (not shown). Control passes to block 228 in which the standardized software driver turns power on to the card. Control passes to block 230 in which the standardized software driver initializes the card in accordance with standard practice. Control passes to block 232 in which the standardized software driver reports the card's presence to the operating system of the personal computer, for example, and communicates with the card normally. Control remains with block 232 until the card is removed from the socket 134. When the card is removed from the socket 134, the SD switching logic/card detector 126 clears the SD switch bit 114 via two way bus 118 and control passes to block 236. In block 236 the SD switching logic/card detector 126 switches the signals coming from the card along bus 132 from two way bus 122 to two way bus 120. The signals from the card are thus coupled again to the non-standardized host controller. Control passes via line 238 to the empty socket state at block 202 and the process repeats when a new card in inserted into the socket.

In the examples shown above, both controllers can communicate with SD cards. It is a design choice as to which of the controllers is chosen for SD cards. In the illustrated embodiment, the standardized controller is chosen for SD cards, so that a card can function with the standardized software driver.

While the invention has been shown and described with reference to preferred embodiments thereof, it is well understood by those skilled in the art that various changes and modifications can be made in the invention without departing from the spirit and scope of the invention as defined by the appended claims. Although the present invention has been illustrated with an embodiment for controlling MMC, SD and SDIO cards, it will be apparent to those skilled in the art that the invention can be applied to any group of cards, whether the cards are flash memory cards, cards sharing the same socket as flash memory cards, or a group of cards that share another socket type, without departing from the present invention.

1. A method of operating a computer system to communicate with a memory card comprising:
detecting a card detect signal from a card socket by a non-standardized controller;
activating a first software driver for the non-standardized controller;
powering the memory card and determining memory card type by the first software driver;
if the memory card type detected is not supported by the non-standardized controller, switching signals from/to the memory card to the standardized controller,
detecting the card detect signal from the card socket by the standardized controller;
activating a second software driver for the standardized controller;
powering the memory card and communicating with the memory card by the second software driver.

2. Method of claim 1 wherein the memory card is an MMC, SD or SDIO card.

3. Method of claim 1 further comprising if the memory card type detected is supported by the non-standardized controller, the non-standardized controller communicates with the memory card.

4. Method of claim 2 further comprising if the memory card type detected is supported by the non-standardized controller, the non-standardized controller communicates with the memory card.

5. Method of claim 1 wherein the first software driver sets a bit in the non-standardized controller and switching logic switches the signals from the memory card to the standardized controller.

6. Method of claim 2 wherein the first software driver sets a bit in the non-standardized controller and switching logic switches the signals from the memory card to the standardized controller.

7. Method of claim 6 wherein MMC cards are coupled to the non-standardized controller and SD and SDIO cards are coupled to the standardized controller.

8. Method of claim 5 further comprising clearing the set bit when the memory card is removed from the socket and the switching logic switching signals from the card to the non-standardized controller.

9. Method of claim 6 further comprising clearing the set bit when the memory card is removed from the socket and the switching logic switching signals from the card to the non-standardized controller.

10. Method of claim 7 further comprising clearing the set bit when the memory card is removed from the socket and, the switching logic switching signals from the card to the non-standardized controller.

11. A computer system having a socket for communicating with a memory card comprising:
a memory card socket for receiving a memory card therein;
a memory card detector detecting the presence of the memory card in the socket and generating a card detect signal;
a non-standardized controller coupled to the socket for receiving and detecting the card detect signal;
a first software driver within the computer system for driving and powering the memory card via the non-standardized controller, the first driver determining memory card type;
a switch coupling signals from/to the memory card socket to the non-standardized controller at a first setting or to a standardized controller at a second setting, the switch being responsive to the determined memory type, the standardized controller detecting the card detect signal and activating a second software driver in the computer system for driving and powering the memory card via the standardized controller, the second driver communicating with the memory card.

12. Computer system of claim 11 wherein the memory card is an MMC, SD or SDIO card.

13. Computer system of claim 11 further comprising if the memory card type detected is supported by the non-standardized controller, the non-standardized controller communicates with the memory card.

14. Computer system of claim 12 further comprising if the memory card type detected is supported by the non-standardized controller, the non-standardized controller communicates with the memory card.

15. Computer system of claim 11 further comprising a memory for storing a bit indicative of the memory card type; and a switching circuit responsive to the bit switching signals from/to the memory card to the standardized controller.

16. Computer system of claim 12 further comprising a memory for storing a bit indicative of the memory card type; and a switching circuit responsive to the bit switching signals from/to the memory card to the standardized controller.

17. Computer system of claim 16 wherein MMC cards are coupled to the non-standardized controller and SD and SDIO cards are coupled to the standardized controller.

18. Computer system of claim 15 further comprising means for clearing the set bit when the memory card is removed from the socket, the switching logic switches signals from the card to the non-standardized controller.

19. Computer system of claim 16 further comprising means for clearing the set bit when the memory card is removed from the socket and switching signals from the card to the non-standardized controller.

20. Computer system of claim 17 further comprising means for clearing the set bit when the memory card is removed from the socket and switching signals from the card to the non-standardized controller.

21. Method of claim 1 wherein memory card types supported by both the standardized and non-standardized controllers are coupled to the standardized controller.

22. Method of claim 1 wherein memory card types supported by both the standardized and non-standardized controllers are coupled to the non-standardized controller.

23. Method of claim 6 wherein MMC and SD cards are coupled to the non-standardized controller and SDIO cards are coupled to the standardized controller.

24. Computer system of claim 16 wherein MMC and SD cards are coupled to the non-standardized controller and SDIO cards are coupled to the standardized controller.

25. Method of claim 23 further comprising clearing the set bit when the memory card is removed from the socket, and the switching logic switching signals from the card to the non-standardized controller.

26. Computer system of claim 24 further comprising means for clearing the set bit when the memory card is removed from the socket and switching signals from the card to the non-standardized controller.
